(19) United States
(12) Patent Application Publication
(10) Pub. No.: US 2001/0049402 A1
(43) Pub. Date: Dec. 6, 2001

(54) Polyisobutylene injection slurry for pipeline use

(76) Inventor: Cy E. Foster, Midland, TX (US)

Correspondence Address: Ann C. Livingston, Baker Botts L.L.P., Suite 600`, 2001 Ross Avenue, Dallas, TX, 75201-2980, US

(21) Appl. No.: 09/847,763

(22) Filed: May 2, 2001

Related U.S. Application Data
(60) Provisional application No. 60/201,657, filed on May 3, 2000.

(51) Int. Cl. C08L 1/00; C08K 3/00; C08J 3/00

(52) U.S. Cl. 523/122; 524/35; 524/44

(57) ABSTRACT

A drag reduction mixture made from a 30-70 proportion of polyisobutylene particles and water. The mixture further contains a surfactant, a viscosifier, an anti-foaming agent, and a biocide. The mixture can be made as a slurry or suspension, depending on the amount of viscosifier.

### RELATED PATENT APPLICATION

This application claims the benefit of U.S. Provisional Application No. 60/201,657, filed May 3, 2000 and entitled “Polyisobutylene Injection Slurry for Pipeline Use”.

### TECHNICAL FIELD OF THE INVENTION

This invention relates to methods for improving the flow of crude oil or other hydrocarbon products through pipelines, and more particularly to a drag reducing slurry using polyisobutylene.

### BACKGROUND OF THE INVENTION

Drag reduction involves the study of the flow phenomenon by which small amounts of additives can greatly reduce the turbulent friction factor of a flowing liquid. It is well known that various additives can be used to reduce drag in pipelines carrying hydrocarbons such as crude oil or petroleum. Various types of polymers have been used for this purpose.

In a liquid flow system, these additives can be used to reduce energy consumption on pumping, to increase flow rate, and decrease the size of pumps, pipes, and fittings. The beneficial effect of such additives can become evident at just a few parts-per-million (ppm), and may increase to values that depend on the molecular nature of the dilute suspension. The molecular weight seems to play an important part in the drag reduction characteristics. Most of the additives used are polymers of high molecular weight (for ex. polyethylene-oxide).

For example long polymers derived from alfa-olefins are used for drag reduction in commercial pipelines for crude oil and refined oil products (gasoline, diesel, etc.). Pipeline performance is greatly enhanced with the injection of the polymer at each pumping station.

The dilute solution may vary from 1 ppm (part-per-million) to several ppm. Drag savings of 25-30% (sometimes more) have been reported. This means that at constant pumping power, there is a corresponding increase in throughput, or at constant throughput the pumping power can be reduced For example, by injecting polymers (less than 20 ppm) downstream from pumps feeding “bottleneck” sections of the Alaska pipeline, crude oil throughput increased by over 25%.

### SUMMARY OF THE INVENTION

One aspect of the invention is a drag reduction mixture for injection into a pipeline. The mixture contains the following ingredients: water in the ratio of substantially 70% of total weight of the mixture and polyisobutylene in a ratio of substantially 30% of total weight. The polyisobutylene is added in the form of particles of a size ranging from 200-400 microns and a molecular weight of at least 7.2 million. It may also be added as larger particles and mixed to that size. Additional ingredients are a surfactant, a viscosifier, a biocide, and an anti-foaming agent.

An advantage of the invention is that it provides an effective drag reduction material. Unlike drag reducing mixtures made from poly alpha olefin, the mixture leaves no ash when burned in an internal combustion engine or in the primary crude unit at a refinery. The various ingredients solve various problems associated with using water as a carrier.

### DETAILED DESCRIPTION OF THE INVENTION

The following description is directed to a drag reducing mixture that uses polyisobutylene as the primary drag reducing agent. A process of producing an optimum slurry or suspension is described, whereby problems associated with injecting the slurry or suspension into a hydrocarbon pipeline are overcome. As explained below, the drag reduction mixture exhibits a viscoelasticity that reduces friction pressure created by turbulent flow in a hydrocarbon pipeline.

Polyisobutylene is a single long chain polymer. It has been effectively used as an additive for internal combustion engines.

For purposes of the present invention, the polyisobutylene used as the source material is in the form of small particles with a high molecular weight. An example of a suitable source material is polyisobutylene particles that are 200-400 microns in size with a molecular weight of at least 7 million. These particles are typically manufactured by cryogenically grinding larger pellets. Ideally, the particles are sufficiently small so as to provide a stable slurry or suspension but without loss of molecular weight.

The cryogenic grinding process is performed at a temperature that is below the glass transition point of the polyisobutylene. Once the material is ground, a partitioning agent, such as a polyethylene wax can be added to prevent reconglomeration.

The carrier for the slurry or suspension is a non-solvating liquid. Examples of such liquids are soybean oil, fish oils, methanol, methanol and water mixtures, isopropyl alcohol, and ethylene glycol, and water.

Experimentation indicated that a suitable carrier is water.

A feature of the invention is that various problems encountered with using water as a carrier were overcome, using various addition constituent materials in the drag reduction mixture. These problems included formation of bacteria, low viscosity, freezing, foaming, and hydrophilic-lipophilic balance (HLB) control.

The drag reduction mixture has the following elements in the following proportions for a one gallon quantity:

| | | |
|---|---|---|
| water | 5.44 | pounds |
| Triton X-100 | .11 | |
| Hydroxy ethyl cellulose | .05 | |
| Silicon anti-foam | .15 | |
| Polyisobutylene particles | 2.45 | |
| Biocide | .04 | |

for a total of 8.24 pounds of the mixture.

The following tables set out the constituent amounts for a mixture for a 55 gallon drum:

| | | |
|---|---|---|
| water | 299.25 | pounds |
| surfactant | 6.25 | |
| Hydroxy ethyl cellulose | 2.5 | |
| Silicon anti-foam | 8.5 | |
| Polyisobutylene particles | 137.5 | |
| Biocide | 2.25 | |

An example of a suitable surfactant is Triton X-100, a product of the Union Carbide Corporation. Triton X-100 is a octylphenoxy polyethoxyethanol surfactant, which is used for HLB control. This material has an HLB number of 13.5. Where more rapid solubility of the slurry is required, Triton X-15 with an HLB number of 3.5 may be used.

The hydroxy ethyl cellulose (HEC) is a thickening agent (viscosifier), to improve flow viscosity. The above formulations are for slurry. As an alternative, a suspension may be made by adding additional HEC. For example, in the one gallon formation, a suspension would be made from 4 pounds of HEC rather than 2.5 pounds.

The biocide is a water soluble biocide, such as DOWKIL 75, manufactured by the Dow Chemical Company. If desired, an anti-freezing agent, such as ethylene glycol, can be added.

The formulations set out above reflect a 30% ratio of polyisobutylene to water, where water is assumed to weigh 8.3 pounds per gallon. The other ingredients are in ratios of about 1.4%, 0.55%, and 0.5% for the surfactant, viscosifier, and biocide and about 1.9% for the anti foaming agent. A range of 0% to 5% can be considered a “substantially” accurate margin of error for the water and polyisobutylene ratios, and range of 0% to 0.1% is a “substantially” accurate margin of error for the other ingredients. The viscosifier (HEC) is accurate to the amount of water.

Typically, injection of the drag reduction mixture into a pipeline occurs in the field. The equipment used for the injection can be easily placed on a skid or other platform, suitable for being carried on a truck or trailer. A conventional injection pump may be used, typically a high volume high pressure chemical injection pump powered by an explosion proof motor. The pump is of a type capable of injection a 30% mixture, that is, a mixture comprising about 30 percent polyisobutylene particles and 70 percent water.

The above-described constituents of the drag reduction mixture may be pre-mixed and stored in a drum or other container. At the injection site, the material is placed in a mixing tank and mixed with a conventional slow mixer prior to injection. The mixer may be mounted in the tank. Although the amount of HEC can be increased for stability, resulting in a suspension rather than a slurry, such a mixture may be more likely to cause the pump to overload and clog.

If the polyisobutylene particles are not sufficiently small, additional mixing may be performed to reduce the particle size. For example a second mixer could be added to the mixing tank. Experimentation has indicated that additional mixing may be used to reduce a source particle size of 1000-1500 microns to the desired size of 200-400 microns. As stated above, the grinding or other reduction of particle size must balance the need for small particles while maintaining a desired molecular weight. The additional mixing has been successful within these particle size ranges, without using cryogenic processes. Any loss of partitioning agent resulting from the additional mixing has not been problematic in terms of reagglomeration.

The injection may occur at any standard pipeline injection inlet. The injection pump is placed above the valve and connected to the valve, and the valve is opened.

Other Embodiments

Although the present invention has been described in detail, it should be understood that various changes, substitutions, and alterations can be made hereto without departing from the spirit and scope of the invention as defined by the appended claims.

What is claimed is:

1. A drag reduction mixture for injection into a pipeline, comprising:
water in the ratio of substantially 70% of total weight of the mixture;
polyisobutylene in a ratio of substantially 30% of total weight, the polyisobutylene being in the form of particles of a size ranging from 200-400 microns and a molecular weight of at least 7.2 million;
surfactant in a ratio of substantially 1.4% of total weight;
viscosifier in a ratio of substantially 0.55% of total weight; and
biocide in a ratio of substantially 0.5% of total weight.

2. The mixture of claim 1, further comprising an anti-foam agent in a ratio of substantially 1.9% of total weight.

3. The mixture of claim 1, wherein the polyisobutylene are cryogenically ground particles.

4. The mixture of claim 1, wherein the polyisobutylene particles contain a partitioning agent.

5. The mixture of claim 1, further comprising sufficient additional viscosifier such that the mixture is a suspension.

6. The mixture of claim 5, wherein the viscosifier is a ratio of substantially 0.1% by weight.

7. The mixture of claim 1, wherein the viscosifier is hydroxy ethyl cellulose.

8. The mixture of claim 1, wherein the surfactant is octylphenoxy polyethoxyethanol.

9. The mixture of claim 1, wherein the surfactant has an HLB number in the range of 3.5 to 13.5.

10. A method of preparing a drag reduction mixture for injection into a pipeline, comprising the steps of:
mixing the following ingredients: water in the ratio of substantially 70% of total weight of the mixture; source polyisobutylene in a ratio of substantially 30% of total weight; surfactant in a ratio of substantially 1.4% of total weight; viscosifier in a ratio of substantially 0.55% of total weight; biocide in a ratio of substantially 0.5% of total weight; and
further mixing the polyisobutylene to form particles of a size ranging from 200-400 microns and a molecular weight of at least 7.2 million.

11. The method of claim 10, further comprising an anti-foam agent in a ratio of substantially 1.9% of total weight.

12. The method of claim 10, wherein the polyisobutylene are cryogenically ground particles.

13. The method of claim 10, wherein the polyisobutylene particles contain a partitioning agent.

14. The method of claim 10, further comprising sufficient additional viscosifier such that the mixture is a suspension.

15. The method of claim 14, wherein the viscosifier is a ratio of substantially 1.0% by weight.

16. The method of claim 10, wherein the viscosifier is hydroxy ethyl cellulose.

17. The method of claim 10, wherein the source polyisobutylene is in the form of particles as large as 1500 microns.

18. The method of claim 10, wherein the surfactant is octylphenoxy polyethoxyethanol.

19. The method of claim 10, wherein the surfactant has an HLB number in the range of 3.5 to 13.5.
